(19) United States
(12) Patent Application Publication
(10) Pub. No.: US 2005/0124305 A1
(43) Pub. Date: Jun. 9, 2005

(54) Methods and apparatus for adjusting the transmission power of a radio transmitter

(76) Inventor: Thomas Stichelbout, Aalborg (DK)

Correspondence Address: Bell, Boyd & Lloyd LLC, P.O. Box 1135, Chicago, IL, 60690-1135, US

(21) Appl. No.: 10/890,681

(22) Filed: Jul. 13, 2004

(30) Foreign Application Priority Data
Nov. 20, 2003 (EP) 03026485.7

(51) Int. Cl. H04B 1/04

(52) U.S. Cl. 455/117; 455/522

(57) ABSTRACT

Methods and apparatus for adjusting the transmission power of a portable radio transmitter are disclosed. The apparatus includes a power setting unit responsive to a proximity detector that lowers the transmission power of the portable radio transmitter when a person is in proximity to the transmitter and increases transmission power when a person is not in proximity to the transmitter. The power setting unit determines the amount of power increase or decrease in such a way that the transmission power of the transmitter is kept in a same power class as prior to the decreasing or increasing of the transmission power.

### BACKGROUND

The present disclosure relates to power control in radio transmitters, especially when a user (i.e., a person using the portable radio transmitter) is in the proximity of the radio transmitter.

In the area of radio transmitters, one of the greatest concerns has been the sensitivity of human tissue to electromagnetic radiation. For example, in current mobile communications devices in the 900 MHz or 1800 MHz bands, radio waves in the microwave spectrum typically have a wavelength of 8 to 16 cm. Even though no results showing any adverse effects have been obtained yet, most device manufacturers have been considering different measures for reducing absorption rates.

One possible way to reduce absorption is to decrease the average power level of the transmitter. A known technique shows one good possibility aimed to reduce the Specific Absorption Rate (SAR). In this technique, a proximity detector is used to detect the presence of the user. If the user is not in the proximity of the device, it can be assumed that the absorption rate is low, so that the average transmission power of the transmitter does not need to be reduced. In the opposite case, the power level is reduced but only to a point necessary to maintain adequate signal strength.

In other words, the transmission power of the radio transmitter is lowered by a predefined step when the user is in the proximity of the radio transmitter, or, conversely, increased by a predefined step when the user is not in the proximity of the radio transmitter.

Typically, the mobile terminal selects the transmitter power level as commanded by a Base Station BS or Radio Network Controller RNC of the mobile network under the coverage area in which the mobile terminal is roaming. The selection of an adequate power level is not too straightforward a task because of the relative complexity of a cellular Radio Access Network (RAN). For example, inter-channel interference is a topic that has to be addressed. Therefore the radio transmission and reception has been standardized. 3GPP TS 45.005 V5.2.0 is the standard for GSM/EDGE, for example. A mobile terminal has to be in conformity to relevant standards.

Therefore it still remains a problem to further reduce the SAR caused by a radio transmitter, especially such that as used in a mobile communications device, in such a manner that conformity to the relevant standard still can be obtained.

### SUMMARY

According to an example, an apparatus is provided to address the transmission power of a portable radio transmitter. The apparatus includes a proximity detector configured to detect the proximity of a person to the portable radio transmitter. The apparatus also includes a power setting unit responsive to the proximity detector and configured to one of lower transmission power of the portable radio transmitter by a first predetermined step when the person is in proximity of the portable radio transmitter and increase the transmission power of the portable radio transmitter by a second predetermined step when the person is not in the proximity of the portable radio transmitter. The power setting unit is also configured to set an amount of the first and second predetermined steps such that the transmission power of the portable radio transmitter belongs to a same power class that the portable radio transmitter will belong to prior to lowering or increasing the transmission power.

In another example, a method is provided to adjust the transmission power of a portable radio transmitter. The method includes detecting when a person is in proximity to the portable radio transmitter. Based on this detection, the transmission power of the radio transmitter is lowered by a first predetermined step when a person is detected in proximity of the transmitter and increased by a second predetermined step when a person is not detected in proximity of the radio transmitter. The first and second predetermined steps for respectively lowering or increasing the transmission power of the portable radio transmitter are determined such that the transmission power of the portable radio transmitter belongs to a same power class that the portable radio transmitter belongs to prior to lowering or increasing the transmission power.

### BRIEF DESCRIPTION OF THE DRAWINGS

FIG. 1 illustrates transmission power in dBm vs. power class and how a predefined step can be selected.

FIG. 2 illustrates transmission power of a radio transmitter as a function of time.

FIG. 3 illustrates functional blocks of a mobile communications device that are relevant for transmitting.

FIG. 4A is a flow chart illustrating how the transmission power can be changed.

FIG. 4B is a flow chart illustrating how the predefined step can be selected.

FIGS. 5A, 5B, and 5C illustrate different ways in which the transmission power can be changed.

FIG. 6 illustrates how at least two detectors for detecting the proximity of the user can be implemented in a mobile communications device.

### DETAILED DESCRIPTION OF THE PRESENT EXAMPLES

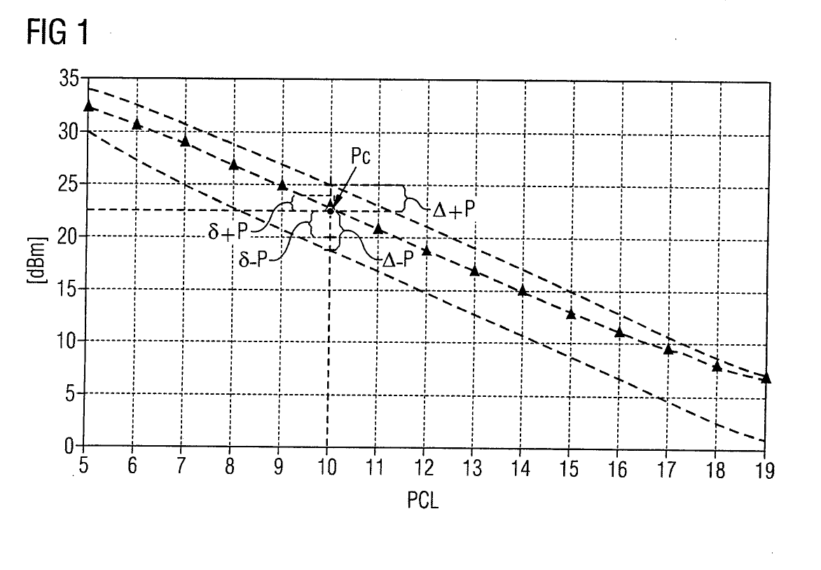

In FIG. 1 the dashed line with triangles shows which path the current transmission power P_{c} of a radio transmitter in dBm would follow as a function of power class PCL. The upper and lower dotted lines show a band defining predefined power level limits [P_{c}−Δ_P; P_{c}+Δ₊P] for each PCL value. These values can be taken from a standard defining the requirements for a transmitter.

For a given PCL value, the power P must be selected from the band shown as dotted lines. The main principle of the present invention is that if the user is in proximity of the transmitter, then the transmitter power P is obtained by reducing the current transmission power P_{c} by a predefined step δ_P, or if the user is not in proximity of the transmitter, than the transmitter power P is obtained by increasing the current transmission power P_{c} by a predefined step δ₊P.

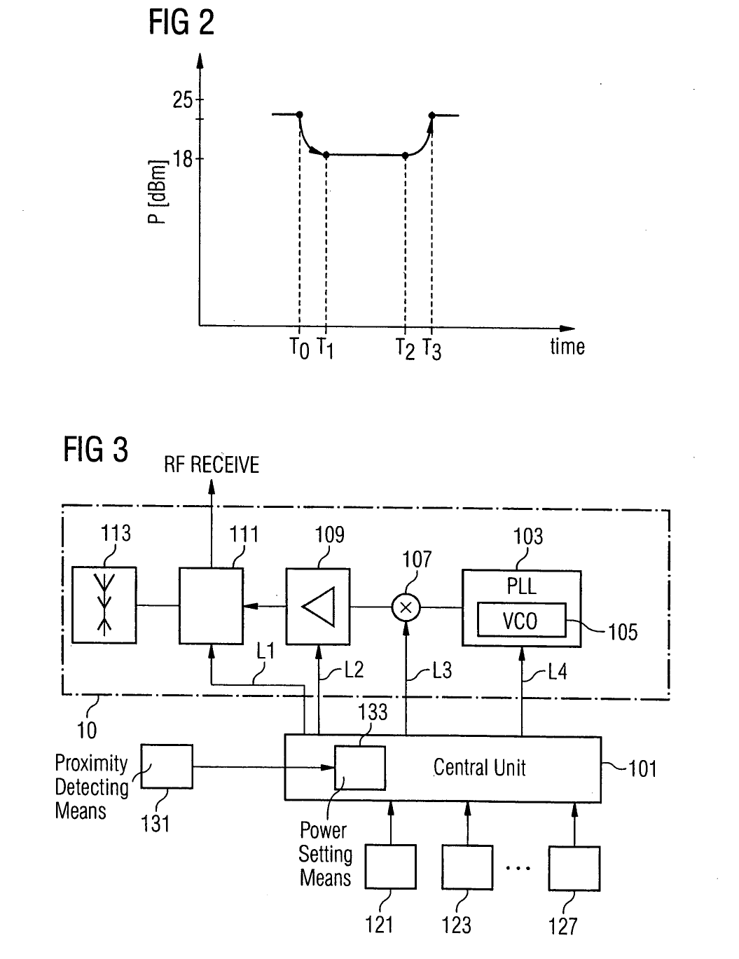

FIG. 2 shows the transmission power of a GSM 900 radio transmitter as a function of time for an example where the power class of the transmitter is 10. Before time T₀ the transmission power P of the transmitter is 22 dBm. At time T₀ the detecting means for detecting the proximity of a user detects that the user is in proximity of the transmitter. Thus, a predefined step δ_P is selected and the transmission power P is lowered by the predefined step δ_P. At time T₁ the transmission power has reached the new value of 18 dBm. At time T₂ the detecting means for detecting the proximity of a user detects that the user is not in proximity of the transmitter anymore. Accordingly, a predefined step δ₊P is selected and the transmission power P is increased by the predefined step δ₊P. At time T₃ the transmission power P has reached the new value, which, in this case, corresponds to the initial value of 22 dBm. The power class is not changed from the transition between T₀ and T₁.

FIG. 3 shows some functional blocks of a mobile communications device that are relevant for transmitting. The main functional components of the transmitter 10 are further expanded in more detail.

A central unit 101 controls the operation of the transmitter 10 through different control channels of which L1, L2, L3, and L4 are shown in FIG. 3. Control channel L1 is used to select the match of a matching circuit 111 for the antenna 113. Control channel L2 is used for defining the ramp shape, power level, and switch signal of a power amplifier 109. Control channel L3 provides a modulator 107 with I and Q signals. Finally, control channel L4 is the frequency control channel that takes control over the voltage of a Voltage Controlled Oscillator VCO 105 in a Phase-Locked Loop PLL 103.

Central unit 101 is also connected to a number of input devices. Examples of such input devices include microphone 121, keyboard 123, and camera 127. The central unit 101 is further connected to a proximity detector 131 to detect the proximity of a user. The central unit 101 includes a power setting unit 133 that is adapted to lower the transmission power of the radio transmitter 10 with a predefined step δ_P when the user is in a proximity of the radio transmitter 10, or to increase the transmission power of the radio transmitter 10 with a predefined step 8₊P when the user is not in proximity of the radio transmitter 10. The power setting unit 133 is adapted to select the predefined step δ_P or δ₊P in such a manner that the transmission power of the transmitter 10 belongs to a same power class PCL as before lowering or increasing the transmission power.

Additionally, the power setting unit 133 is adapted to inhibit the lowering or increasing of the transmission power if the lowering or increasing would lead to change of the transmission power causing a change in the power class PCL of the radio transmitter 10.

Further, the predefined step δ_P or δ₊P is calculated as a function of current power Pc and a current power class PCL, whereby a predefined power level limit Δ₊P or Δ_P is used depending on current power class PCL or a value derived therefrom.

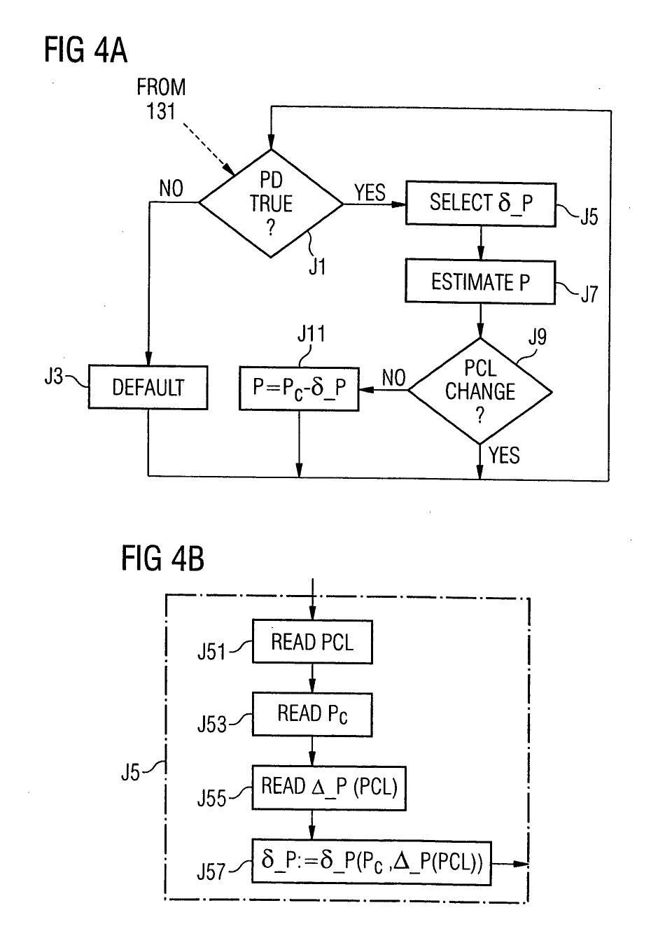

FIG. 4A is a flow chart showing how the transmission power can be changed. At decision block J1 a proximity detection signal PD issued by the proximity detector 131 is analyzed. If the proximity detection signal PD is not true, the default power level corresponding the power class PCL is set as indicated in block J3, after which there is a return to decision block J1. In the alternative case, a predefined step δ_P is selected as indicated in block J5. The resulting power P is then estimated as shown in block J7. Next, a check whether or not the change of current power P_{c} to P (P=P_{c}−δ_P) would result in change of PCL is performed as indicated in decision block J9. If the PCL is not changed, then in step the new power P is set in step J11, after which there is a return to step J1. In the opposite case the power P is not changed, but there is a return to step J1.

FIG. 4B illustrates in more detail the procedure performed in block J5. At block J51 the power class PCL is read. Next, as shown in block J53, the current power P_{c} is read. Then. based on the PCL, the predefined power level limit Δ_P is retrieved from memory as shown in block J55. These values can be stored into a table, for example. At block J57 the predefined step δ_P is computed as a function of current power PC and predefined power level limit Δ_P, or, because the Δ_P is a function of PCL, as a function of current power Pc and PCL. In other words, depending on the comparison result in decision block J1, the target value for the transmitted power is adjusted to a low value within the acceptable range for the present PCL as defined in the specifications, or to a middle range within the acceptable range for the present PCL as defined in the specifications. The low value does not necessarily mean the absolutely lowest acceptable value. An example of the mapping 5 function can be δ_P=P_{c}−a Δ_P, where a is a scaling factor [0, 1]. In particular, a values ¼; 1/24; and ¾ may be used.

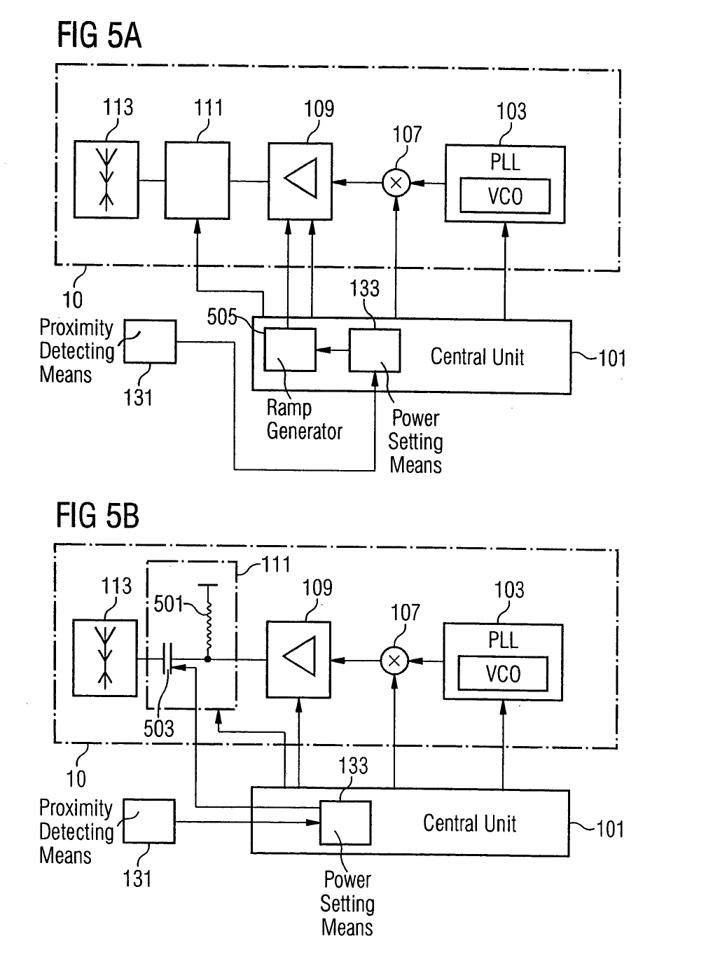

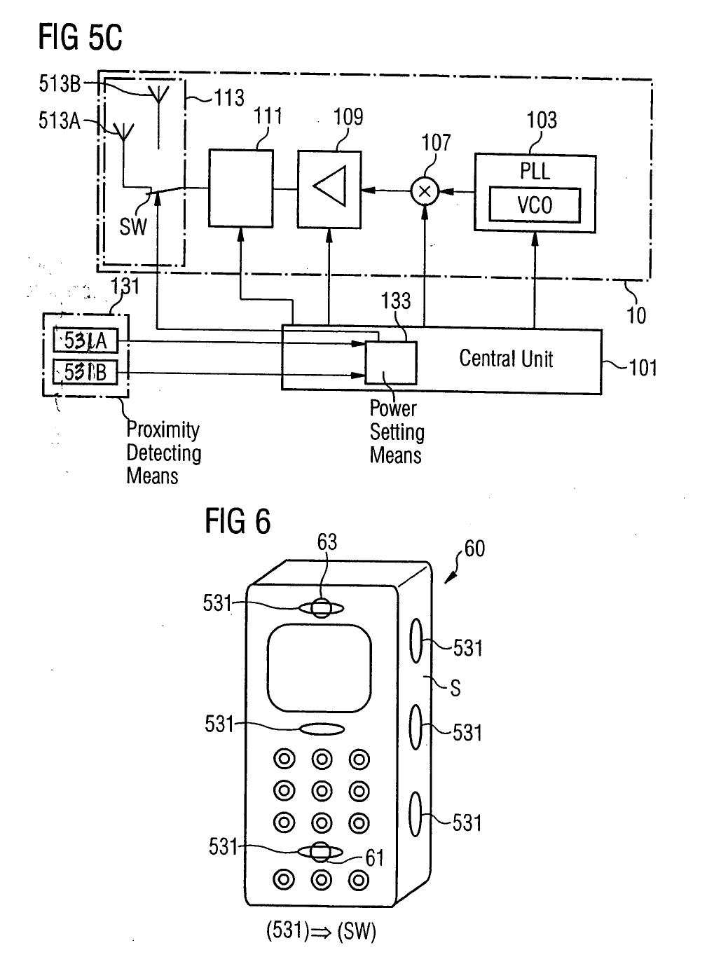

FIG. 5A illustrates an exemplary apparatus that performs transmission power lowering or increasing by adapting the ramp shape of power amplifier 109. The ramp generator 505 in the central unit 101 is now responsive to power setting unit 133, which is, in turn, responsive to proximity detector 131 for detecting the proximity of a user. A suitable ramp shape (i.e., average power within a burst and/or ramp rising/decaying shape) is selected by the ramp generator 505 using information received from the power setting unit 133.

FIG. 5B illustrates an exemplary apparatus that can lower or increase the transmission power by changing the reflection coefficient of an antenna 113 by selecting a different antenna match 111. The antenna match 111 includes inductive elements 501 and capacitive elements 503. If the capacitive element 503 is a variable capacitor (varactor), its control voltage can be changed appropriately. Accordingly, the power setting unit 133, which is responsive to proximity detector 131, is adapted to control the antenna match 111 element.

FIG. 5C illustrates an exemplary apparatus that lowers or increases transmission power by selecting between first and second antennas 513A, 513B depending which one of proximity detectors 531A, 531B in the proximity detector 131 detects the proximity of the user. The selecting can be done by controlling the position of a switch SW between the antennas 513A, 513B. The power setting unit 133 is responsive to both of the proximity detectors 531A and, 531B. The actual number of antennas can also be larger (three, four, etc.) if this is considered beneficial.

The first antenna 513A is either located further away from the user than the second antenna 513B, or its radiation pattern is adapted to cause a smaller SAR to the user by using suitable shielding means, for example. In the latter case, there may be reflection or attenuation of the radiated signal, therefore reducing the efficiency. If the second antenna 513B is used when the user is not in the proximity of the transmitter, it may result in better efficiency of the transmitter. Efficiency is advantageous, as such, because it leads to smaller current consumption. This is especially beneficial in portable communication devices, which are operated by current obtained from a rechargeable battery, because small current consumption affords longer operation time before recharging the battery.

FIG. 6 shows an example of a portable communication device 60 according to the present disclosed apparatus. Included in this apparatus is a plurality of proximity detectors 531 for detecting the proximity of a user. For example, there can be separate proximity detectors in the vicinity of the microphone 61a and the loudspeaker 63. Further, on a side S there may be further detectors 531 for detecting the proximity of a user.

The input of all the proximity detectors 531 together can have a vector format. The vector (531) can be used to produce a switch vector (SW). It is noted that there may be up to three antenna elements, namely one at the top, one at the bottom of the portable communication device 60 and a third antenna element can be located on the side S. The positions of the switches SW selecting between these three antennas are selected to produce a smallest possible SAR value.

If the user is close to the transmitter 10 in one direction, only the transmission pattern of an array of the antennas can be adapted to avoid the given direction. This is also useful if the transmitter 10 or the portable communication device 60 is placed on a metallic surface, as the transmission pattern of the transmitter 10 can be adapted to the changed environment. It is noted that any kind of known proximity detector may be used with the disclosed methods and apparatus for detecting the proximity of a user. Further, in the case of two or more proximity detectors 131 in one portable communication device 60, these detectors need not to be of the same kind. For example, the combination of an impedance proximity with an optical proximity detector may be used.

Also the transmission power of a different transceiver (Bluetooth, IrDA, WLAN) in the portable communication device 60 can be used to provide at least a part of the sensor vector (531).

The specific communication standard that the transmitter 10 or the portable communication device 60 is adapted to follow is immaterial for practicing the presently disclosed apparatus and methods. Basically, all GSM/EDGE/3G standards have a power classification defined, and, therefore, all of these standards are usable.

By selecting the predefined step with which the transmission power of the radio transmitter is lowered in such a manner that the transmission power of the transmitter belongs to same power class as before lowering or increasing the transmission power, the SAR can be reduced while still maintaining conformity with the specification and reducing the extra messaging and work at the RAN. In most cases the RAN does not need to define a new power class for the transmitter, which saves processing effort. Further, the calculated power class does not need to be transmitted to the transmitter, therefore also saving signalling in the air interface.

When the person using the portable radio transmitter is not in the proximity of the transmitter anymore, the transmission power can be increased in a similar manner as well. The advantages are essentially similar. Further, by inhibiting the lowering or increasing of the transmission power if such lowering or increasing would lead to change of the transmission power causing a change in the power class of the radio transmitter, the probability of an unnecessary power class change by the RAN can be reduced. This helps further to reduce the SAR value, because the resulting higher new power class determined by the RAN could result in increasing the SAR.

When the predefined step is calculated as a function of current power and a current power class, whereby predefined power level limits are used dependent on current power class or a value derived therefrom, the target power level can be reached faster. This can be used for further reducing of SAR.

Although preferred examples of the present methods and apparatus have been disclosed for illustrative purposes, those of ordinary skill in the art will appreciate that the scope of this patent is not limited thereto. On the contrary, this patent covers all methods and apparatus falling within the scope of the appended claims.

1. An apparatus to adjust the transmission power of a portable radio transmitter comprising:
a proximity detector configured to detect the proximity of a person to the portable radio transmitter; and
a power setting unit responsive to the proximity detector and configured to one of lower transmission power of the portable radio transmitter by a first predetermined step when the person is in proximity of the portable radio transmitter or increase the transmission power of the portable radio transmitter by a second predetermined step when the person is not in the proximity of the portable radio transmitter;
wherein the power setting unit is configured to set an amount of the first and second predetermined steps such that the transmission power of the portable radio transmitter belongs to a same power class that the portable radio transmitter belonged prior to lowering or increasing the transmission power.

2. An apparatus as defined in claim 1, wherein the power setting unit is configured to inhibit the lowering or increasing of the transmission power when lowering or increasing would change the transmission power such that the power class of the portable radio transmitter would be changed.

3. An apparatus as defined in claim 1, wherein the first and second predetermined steps are calculated as a function of current power and a current power class, and a prescribed power level limit is used dependant on one of the current power class and a value derived from the current power class.

4. An apparatus as defined in claim 1, further comprising:
a power amplifier; and
wherein lowering or increasing of the transmission power is accomplished by adaptation of a ramp shape of the power amplifier.

5. An apparatus as defined in claim 1, further comprising:
an antenna; and
wherein the lowering or increasing of the transmission power is accomplished by changing a reflection coefficient of the antenna by selecting an antenna match.

6. An apparatus as defined in claim 1, further comprising:
first and second antennas;
the proximity detector including first and second detectors; and
wherein the power setting unit is further configured to respond to at least signals received from the first and second detectors; and to select between the first and second antennas dependent on which one of the first and second detectors detects the proximity of the person using the portable radio transmitter.

7. A portable communications device comprising utilizing the apparatus as defined in claim 1.

8. A portable communications device (60) of claim 7, wherein the portable communications device is a mobile communication device operable in a GSM/EDGE/3G system.

9. A method for adjusting the transmission power of a portable radio transmitter comprising:
detecting when a person is in proximity of the portable radio transmitter;
lowering transmission power of the radio transmitter by a first predetermined step when a person is detected in proximity of the portable radio transmitter; and
increasing the transmission power of the portable radio transmitter by a second predetermined step when a person is not detected in proximity of the portable radio transmitter;
wherein the first and second predetermined steps or respectively lowering or increasing the transmission power of the portable radio transmitter are determined such that the transmission power of the portable radio transmitter belongs to a same power class that the portable radio transmitter belonged prior to lowering or increasing the transmission power.

10. A method as defined in claim 9, further comprising:
inhibiting the lowering or increasing of the transmission power when lowering or increasing would change the transmission power such that the power class of the portable radio transmitter would be changed.

11. A method as defined in claim 9, wherein the first and second predetermined steps are calculated as a function of current power and a current power class, and a prescribed power level limit is used dependant on one of the current power class and a value derived from the current power class.
